(19) United States
(12) Patent Application Publication
(10) Pub. No.: US 2009/0321536 A1
(43) Pub. Date: Dec. 31, 2009

(54) Piston having channel extending through piston head

(75) Inventor: Goudarz Haji, Bloomington, IL (US)

Correspondence Address: CATERPILLAR/FINNEGAN, HENDERSON, L.L.P., 901 New York Avenue, NW, WASHINGTON, DC, 20001-4413, US

(73) Assignee: Caterpillar Inc.

(21) Appl. No.: 12/216,113

(22) Filed: Jun. 30, 2008

(51) Int. Cl. F02M 47/02

(52) U.S. Cl. 239/88; 92/172

(57) ABSTRACT

A piston is disclosed. The piston may have a piston head, which may have an exterior surface. The exterior surface may have a top portion, an upper side portion, and a lower side portion. The piston may also have a groove formed in the lower side portion of the exterior surface. Additionally, the piston may have a channel extending from the groove through the piston head. The channel may also extend through at least one of the top portion or the upper side portion of the exterior surface.

### TECHNICAL FIELD

The present disclosure relates generally to a piston and, more particularly, to a piston having a channel extending through a piston head of the piston.

### BACKGROUND

Some fuel injectors include an intensifier piston situated within an intensification chamber. The intensifier piston is forced downward from a starting position by actuation fluid to compress and expel high pressure fuel through a nozzle assembly. A spring then forces the piston upward back to the starting position. However, the high pressure fuel may leak past the intensifier piston through the intensification chamber and mix with the actuation fluid.

One way to reduce mixing of fuel and actuation fluid is to isolate the actuation fluid from the fuel. An example of this strategy is described in U.S. Pat. No. 6,568,602 (the '602 patent) issued to Bram et al. on May 27, 2003. The '602 patent describes a check piston disposed within a check piston bore. The check piston incorporates a glide ring seal, which includes a rubber energizer ring and a nylon wear surface. The rubber energizer ring pushes the nylon wear surface against the check piston bore, isolating hydraulic fluid from fuel.

Although the check piston and glide ring seal of the '602 patent may isolate hydraulic fluid from fuel, the check piston of the '602 patent may not help compensate for wear to the nylon wear surface of the glide ring seal of the '602 patent. Specifically, the check piston may not help vent the rubber energizer ring. An improperly vented rubber energizer ring may fail to contract radially inward when the nylon wear surface is worn because a worn nylon wear surface may inhibit communication of hydraulic fluid to and/or from the rubber energizer ring. The rubber energizer ring may fail to contract radially inward when this fluid communication is inhibited. When the rubber energizer ring fails to contract radially inward, it may continually push the nylon wear surface against the check piston bore. The continuous pushing of the nylon wear surface against the check piston bore may inhibit movement of the check piston and potentially cause further undue wear to the nylon wear surface.

The disclosed pistons and injectors are directed to overcoming one or more of the problems set forth above and/or other problems in the art.

### SUMMARY

In one aspect, the present disclosure may be directed to a piston. The piston may include a piston head, which may include an exterior surface. The exterior surface may include a top portion, an upper side portion, and a lower side portion. The piston may also include a groove formed in the lower side portion of the exterior surface. Additionally, the piston may include a channel extending from the groove through the piston head. The channel may also extend through at least one of the top portion or the upper side portion of the exterior surface.

In another aspect, the present disclosure may be directed to a fuel injector. The fuel injector may include an intensification chamber. The fuel injector may also include an intensifier piston, which may be slideably situated within the intensification chamber. The intensifier piston may include a piston head. Additionally, the intensifier piston may include a groove formed in the piston head. The intensifier piston may also include a channel extending through the piston head. Additionally, the fuel injector may include a glide seal, which may be situated at least partially within the groove. The glide seal may include an energizer portion and a wear portion situated radially outward of the energizer portion. The channel may provide fluid communication between the energizer portion and the intensification chamber.

In yet another aspect, the present disclosure may be directed to a hydraulically actuated electronically controlled unit injector. The injector may include an intensification chamber. The injector may also include an intensifier piston, which may be slideably situated within the intensification chamber. The intensifier piston may include a piston head, which may include an exterior surface. The exterior surface may include a top portion, an upper side portion, and a lower side portion. Additionally, the intensifier piston may include a groove, which may be formed in the lower side portion of the exterior surface. The intensifier piston may also include a channel, which may extend from the groove through the piston head. The channel may also extend through at least one of the top portion or the upper side portion of the exterior surface. In addition, the injector may include an actuator, which may be configured to direct an actuation fluid toward the exterior surface of the piston head. The injector may also include a glide seal, which may be situated at least partially within the groove. The glide seal may include an energizer portion and a wear portion situated radially outward of the energizer portion.

### BRIEF DESCRIPTION OF THE DRAWINGS

FIG. 1 is a cross-sectional side view of an exemplary disclosed intensifier piston and an exemplary disclosed check piston, both situated within an exemplary disclosed injector;

FIG. 2 is an enlarged cross-sectional partial side view of the intensifier piston of FIG. 1;

FIG. 3 is an enlarged cross-sectional partial side view of an exemplary disclosed alternate embodiment of the intensifier piston of FIG. 1;

FIG. 4 is an enlarged cross-sectional partial side view of another exemplary disclosed alternative embodiment of the intensifier piston of FIG. 1;

FIG. 5 is an enlarged cross-sectional partial side view of yet another exemplary disclosed alternative embodiment of the intensifier piston of FIG. 1; and

FIG. 6 is a top cross-sectional view of the piston of FIG. 2.

### DETAILED DESCRIPTION

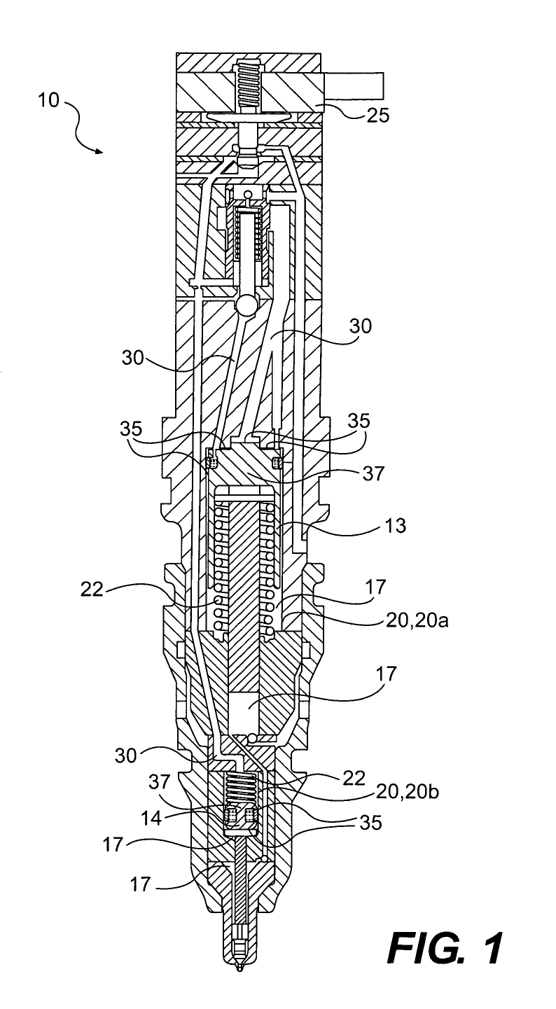

FIG. 1 illustrates an exemplary injector 10 having at least one piston (referring to intensifier piston 13 and/or check piston 14). Injector 10 may be hydraulically, mechanically, or electrically actuated. For example, injector 10 may be, as illustrated, a hydraulically actuated electronically controlled unit injector (HEUI). Alternatively, injector 10 may be a mechanically actuated electronically controlled unit injector (MEUI), a common rail fuel injector, and/or another type of fuel injector known in that art.

The piston may be situated within injector 10 and configured to pressurize and/or route a fuel through a pathway 17 of injector 10. In particular, the piston may be slideably situated within a chamber 20 (referring to intensification chamber 20a and/or check piston bore 20b) of injector 10. The piston may pressurize and/or route the fuel through pathway 17 when moved. For example, intensifier piston 13 may be situated within intensification chamber 20a and configured to pressurize the fuel when moved. As another example, check piston 14 may be situated within check piston bore 20b and configured to route the fuel through pathway 17 when moved. Although intensifier piston 13 may be discussed below, it should be understood that the components and features discussed below may be equally applicable to check piston 14 or another piston known in the art. Additionally, though intensification chamber 20a may be discussed below, it should be understood that the components and features discussed below may be equally applicable to check piston bore 20b or another chamber known in the art.

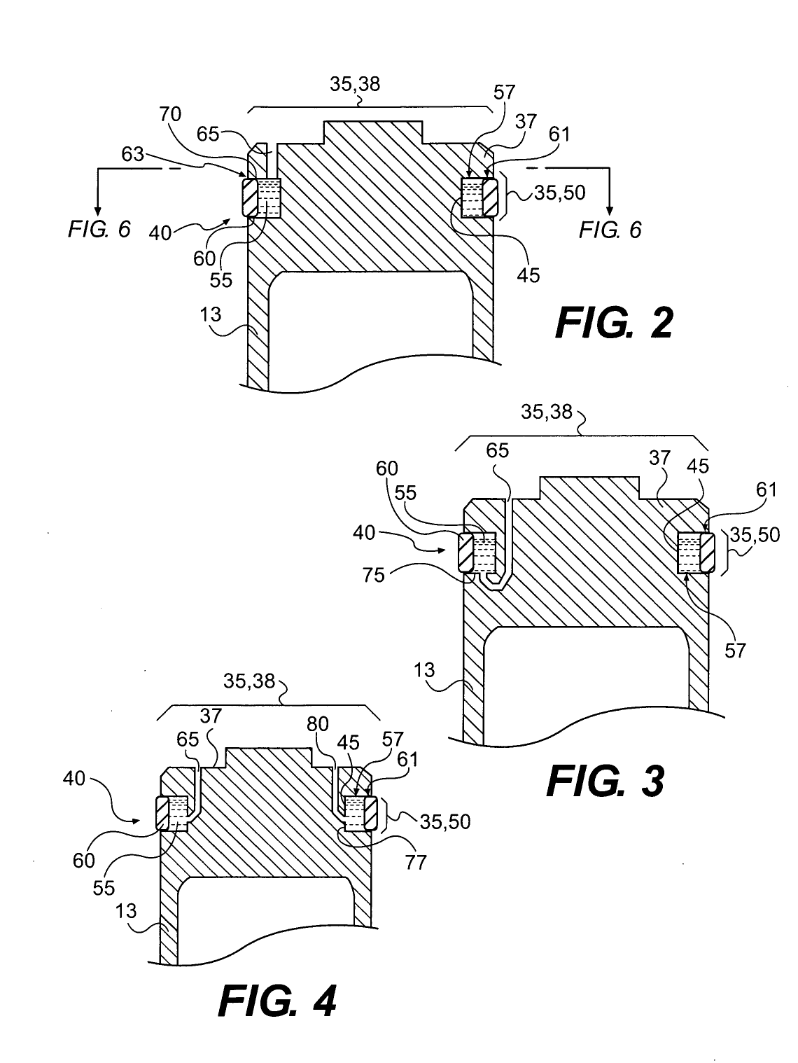

Movement of intensifier piston 13 in a first direction may be by way of a spring 22, which may apply a biasing force to intensifier piston 13. Movement of intensifier piston 13 in a second direction (opposite to the first direction) may be by way of an actuator 25, which may overcome the biasing force by directing an actuation fluid at a high pressure through a pathway 30 toward a piston head 37 of intensifier piston 13. In particular, actuator 25 may direct the actuation fluid into intensification chamber 20a and toward an exterior surface 35 of piston head 37. For example, the actuation fluid may include engine oil, fuel, or another hydraulic fluid known in the art. The directing of actuation fluid through pathway 30 toward exterior surface 35 may increase a force on a top portion 38 of exterior surface 35 of piston head 37 (referring to FIGS. 2-4). This force may overcome the biasing force applied by spring 22 and move intensifier piston 13 in the second direction.

As illustrated in FIGS. 2-5, injector 10 may include a glide seal 40 to intermittently seal intensifier piston 13 against a wall of intensification chamber 20a, thereby isolating the actuation fluid from the fuel. This isolation of the actuation fluid from the fuel may prevent mixing of the actuation fluid and the fuel within intensification chamber 20a.

Glide seal 40 may be at least partially housed by and at least partially situated within a groove 45 formed in a lower side portion 50 of exterior surface 35 of piston head 37. Lower side portion 50 may be substantially orthogonal to top portion 38. In some embodiments, glide seal 40 may include a glide ring seal and groove 45 may include a ring groove. In these embodiments, the glide ring seal may be at least partially housed by and at least partially situated within the ring groove.

Glide seal 40 may include an energizer portion 55 housed by and situated within an energizer portion receiving portion 57 of groove 45. Although energizer portion 55 is illustrated as having a substantially rectangular cross section, energizer portion 55 may have a substantially circular cross section, a substantially x-shaped cross section, or another cross section known in the art. In embodiments where glide seal 40 includes the glide ring seal and groove 45 includes the ring groove, energizer portion 55 may include an energizer ring and energizer portion receiving portion 57 may include an energizer ring receiving portion. In these embodiments, the energizer ring may be housed by and situated within the energizer ring receiving portion.

Glide seal 40 may also include a wear portion 60 at least partially housed by and situated within a wear portion receiving portion 61 of groove 45. Wear portion 60 may be situated radially outward of energizer portion 55. Although wear portion 60 is illustrated as having a substantially rectangular cross section, wear portion 60 may have a substantially circular cross section, a substantially x-shaped cross section, or another cross section known in the art. This cross section may be shaped to provide a gap 63 (referring to FIG. 2) between wear portion 60 and land 70. Gap 63 may sometimes provide fluid communication between energizer portion 55 and intensification chamber 20a. In other words, gap 63 may sometimes fluidly connect energizer portion receiving portion 57 and intensification chamber 20a. In embodiments where glide seal 40 includes the glide ring seal and groove 45 includes the ring groove, wear portion 60 may include a wear ring and wear portion receiving portion 61 may include a wear ring receiving portion. In these embodiments, the wear ring may be at least partially housed by and situated within the wear ring receiving portion.

Energizer portion 55 may expand radially outward (hereafter “energize”) to push wear portion 60 against the wall of intensification chamber 20a (referring to FIG. 1), thereby sealing intensifier piston 13 against the wall of intensification chamber 20a. In particular, energizer portion 55 may energize when contacted by the actuation fluid. This contact may occur when actuator 25 (referring to FIG. 1) directs the actuation fluid through pathway 30 toward exterior surface 35 of piston head 37. Specifically, the actuation fluid may flow toward and contact energizer portion 55 via a channel 65 within piston head 37, which may provide fluid communication between energizer portion 55 and intensification chamber 20a. In other words, channel 65 may fluidly connect energizer portion receiving portion 57 and intensification chamber 20a.

Energizer portion 55 may also contract radially inward (hereafter “de-energize”) to allow wear portion 60 to move away from the wall of intensification chamber 20a, thereby unsealing intensifier piston 13 from the wall of intensification chamber 20a. In particular, energizer portion 55 may de-energize when actuator 25 no longer directs the actuation fluid through pathway 30 toward exterior surface 35 of piston head 37. Specifically, the actuation fluid may, via channel 65, flow away from and cease contact with energizer portion 55 when actuator 25 no longer directs the actuation fluid through pathway 30 toward exterior surface 35. This cessation of contact with the actuation fluid may de-energize energizer portion 55.

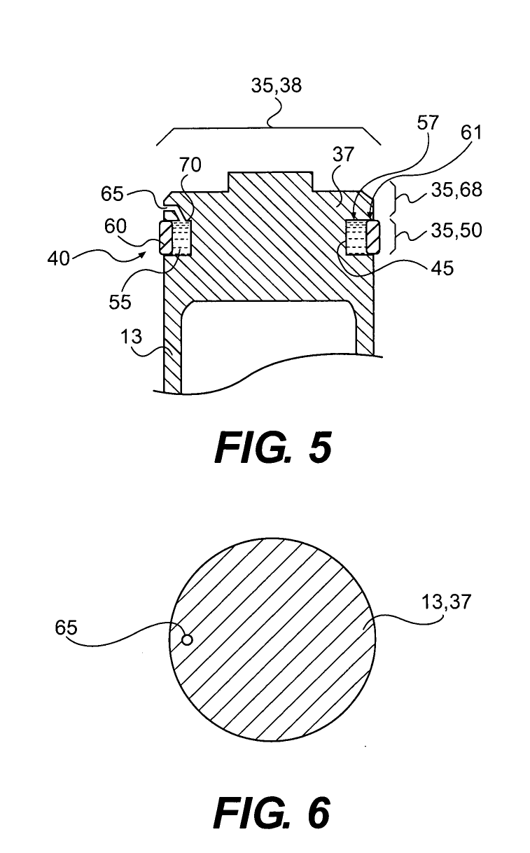

As illustrated in FIGS. 2-5, channel 65 may extend from groove 45 through piston head 37 and through exterior surface 35 of piston head 37. In particular, channel 65 may extend from groove 45 through piston head 37 and top portion 38 (referring to FIGS. 2-4). Alternatively, channel 65 may extend from groove 45 through piston head 37 and an upper side portion 68 of exterior surface 35 (referring to FIG. 5). Upper side portion 68 may be substantially parallel with lower side portion 50. Additionally, channel 65 may extend through a top land 70 of groove 45 (referring to FIGS. 2 and 5). Alternatively, channel 65 may extend through a bottom land 75 of groove 45 (referring to FIG. 3). In yet another alternative embodiment, channel 65 may extend through a back wall 77 of groove 45 (referring to FIG. 4).

As illustrated in FIG. 4, a second channel 80 may also provide fluid communication between energizer portion 55 and intensification chamber 20a. Channel 80 may extend from groove 45 through piston head 37 and through exterior surface 35 of piston head 37. Like channel 65, channel 80 may extend from groove 45 through top portion 38 or upper side portion 68. Additionally, channel 80 may extend from groove 45 through land 70, land 75, or back wall 77.

As illustrated in FIG. 6, channel 65 may have a substantially circular cross section. Alternatively, channel 65 may have a substantially rectangular cross section or another cross section known in the art.

### INDUSTRIAL APPLICABILITY

The disclosed pistons and injectors may be applicable to seals having energizer portions. The pistons and injectors may be particularly beneficial when applied to seals having energizer portions and wear portions. Channels of the pistons may allow fluid to flow toward or away from the energizer portions regardless of whether the wear portions are deformed.

As intensifier piston 13 moves within intensification chamber 20a, it is contemplated that a temperature of the actuation fluid may increase. This increased temperature of the actuation fluid may cause deformation of wear portion 60. Specifically, wear portion 60 may be extruded such that it prevents the actuation fluid from flowing toward or away from energizer portion 55 via gap 63, resulting in inhibition of movement of intensifier piston 13. Channels 65 and/or 80 may, however, prevent this extrusion from inhibiting movement of intensifier piston 13.

Channels 65 and/or 80 may prevent the extrusion from inhibiting movement of intensifier piston 13 by providing fluid communication between energizer portion 55 and intensification chamber 20a despite deformation of wear portion 60. During operation of injector 10, spring 22 may move intensifier piston 13 in a first direction. Actuator 25 may then move intensifier piston 13 in a second direction (opposite to the first direction) by directing the actuation fluid through pathway 30 toward exterior surface 35 of piston head 37. The actuation fluid may flow toward and contact energizer portion 55 via channels 65 and/or 80. This contact may cause energizer portion 55 to energize and push wear portion 60 against the wall of intensification chamber 20a, sealing intensifier piston 13 against the wall of intensification chamber 20a and preventing undesirable mixing of the actuation fluid and the fuel. Specifically, the actuation fluid may be prevented from entering pathway 17 and mixing with the fuel, while the fuel may be prevented from entering pathway 30 and mixing with the actuation fluid. Next, actuator 25 may cease directing the actuation fluid through pathway 30 toward exterior surface 35. The actuation fluid may, at this time and via channels 65 and/or 80, flow away from energizer portion 55. In doing so, the actuation fluid may cease contact with energizer portion 55. This cessation of contact with the actuation fluid may de-energize energizer portion 55 and allow wear portion 60 to move away from the wall of intensification chamber 20a, thereby unsealing intensifier piston 13 from the wall of intensification chamber 20a and allowing spring 22 to uninhibitedly move intensifier piston 13 in the first direction.

It will be apparent to those skilled in the art that various modifications and variations can be made to the pistons and injectors of the present disclosure. Other embodiments of the pistons and injectors will be apparent to those skilled in the art from consideration of the specification and practice of the pistons and injectors disclosed herein. It is intended that the specification and examples be considered as exemplary only, with a true scope of the disclosure being indicated by the following claims and their equivalents.

What is claimed is:

1. A piston, comprising:
a piston head having an exterior surface, the exterior surface including a top portion, an upper side portion, and a lower side portion;
a groove formed in the lower side portion of the exterior surface; and
a channel extending from the groove through the piston head and through at least one of the top portion or the upper side portion of the exterior surface.

2. The piston of claim 1, wherein the channel extends through a land of the groove.

3. The piston of claim 2, wherein the land is a top land of the groove.

4. The piston of claim 1, wherein the channel extends through a back wall of the groove.

5. The piston of claim 1, wherein the channel has a substantially circular cross section.

6. The piston of claim 1, wherein the piston further includes a second channel extending from the groove through the piston head and through the top portion of the exterior surface.

7. The piston of claim 1, wherein the piston further includes a second channel extending from the groove through the piston head and through the upper side portion of the exterior surface.

8. The piston of claim 1, wherein the groove is configured to at least partially house a glide seal, the glide seal being configured to intermittently seal the piston against a wall of a chamber of an injector.

9. The piston of claim 8, wherein:
the groove includes a ring groove, the ring groove including:
an energizer ring receiving portion configured to house an energizer ring of the glide seal; and
a wear ring receiving portion configured to at least partially house a wear ring of the glide seal, the wear ring receiving portion being situated radially outward of the energizer ring receiving portion; and
the channel fluidly connects the energizer ring receiving portion and the chamber.

10. The piston of claim 8, wherein:
the chamber is a check piston bore; and
the piston is a check piston configured to route fuel through the injector.

11. A fuel injector, comprising:
an intensification chamber;
an intensifier piston slideably situated within the intensification chamber, the intensifier piston including:
a piston head,
a groove formed in the piston head, and
a channel extending through the piston head; and
a glide seal situated at least partially within the groove, the glide seal including an energizer portion and a wear portion situated radially outward of the energizer portion, wherein the channel provides fluid communication between the energizer portion and the intensification chamber.

12. The injector of claim 11, wherein the channel extends through a land of the groove.

13. The injector of claim 11, wherein the channel extends through at least one of a top portion or an upper side portion of an exterior surface of the piston head, the groove being formed in a lower side portion of the exterior surface.

14. The injector of claim 11, wherein:
the groove includes a ring groove;
the energizer portion includes an energizer ring; and
the wear portion includes a wear ring.

15. The injector of claim 11, wherein the intensifier piston further includes a second channel extending through the piston head, the second channel providing fluid communication between the energizer portion and the intensification chamber.

16. A hydraulically actuated electronically controlled unit injector, comprising:
an intensification chamber;
an intensifier piston slideably situated within the intensification chamber, the intensifier piston including:
a piston head having an exterior surface, the exterior surface including a top portion, an upper side portion, and a lower side portion;
a groove formed in the lower side portion of the exterior surface; and
a channel extending from the groove through the piston head and through at least one of the top portion or the upper side portion of the exterior surface;
an actuator configured to direct an actuation fluid toward the exterior surface of the piston head; and
a glide seal situated at least partially within the groove, the glide seal including an energizer portion and a wear portion situated radially outward of the energizer portion.

17. The injector of claim 16, wherein the channel extends through a land of the groove.

18. The injector of claim 17, wherein the land is a top land of the groove.

19. The injector of claim 16, wherein the channel extends through a back wall of the groove.

20. The injector of claim 16, wherein the intensifier piston further includes a second channel extending from the groove through the piston head and through at least one of the top portion or the upper side portion of the exterior surface.
